(19) United States
(12) Patent Application Publication
(10) Pub. No.: US 2011/0011697 A1
(43) Pub. Date: Jan. 20, 2011

(54) ELECTROMAGNETIC CLUTCH, RING HOLDER AND METHOD OF MANUFACTURING THE RING HOLDER

(75) Inventors: Toshihiko Ishida, Aichi (JP); Naoya Oku, Aichi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/934,177

(22) PCT Filed: Jun. 22, 2009
(86) PCT No.: PCT/JP2009/061319

§ 371 Date: Sep. 23, 2010

(30) Foreign Application Priority Data
Jul. 2, 2008 (JP) 2008-173727

(51) Int. Cl. F16D 27/04; F16B 1/00; B23P 17/04

(52) U.S. Cl. 192/84.95; 403/24; 29/592

(57) ABSTRACT

An electromagnetic clutch that can be easily miniaturized in a direction of a rotational axis of the clutch comprises a driven gear adapted to be rotatably driven by a motor; a rotor rotatable with the rotational axis that is shared with the driven gear and having an electromagnetic coil provided at one end thereof along the rotational axis; an armature mounted between the driven gear and the rotor to be rotatable in unison with the driven gear, and attracted by the rotor when current is applied to the electromagnetic coil; a clutch case accommodating the driven gear, the rotor and the armature therein; a pair of slip rings mounted on one of the rotor at a region adjacent the clutch case that faces away from the armature, and the clutch case at a region adjacent the rotor; the pair of slip rings being coaxial with the rotational axis and having different radii; and a pair of brush elements mounted on the other of the rotor and the clutch case to come into contact with the pair of slip rings from a radial direction, respectively.

### TECHNICAL FIELD

The present invention relates to an electromagnetic clutch comprising a driven gear adapted to be rotatably driven by a motor, a rotor rotatable with a rotational axis that is shared with the driven gear and having an electromagnetic coil provided at one end thereof along the rotational axis, an armature mounted between the driven gear and the rotor to be rotatable in unison with the driven gear, and attracted by the rotor when current is applied to the electromagnetic coil, a case accommodating the driven gear, the rotor and the armature therein, a pair of slip rings, and a pair of brush elements coming into contact with the pair of slip rings, respectively, from a radial direction, and to a ring holder for holding the slip rings, and to a method of manufacturing the ring holder.

### BACKGROUND ART

An example of the conventional electromagnetic clutches is known, in which the pair of slip rings are displaced or deviated from each other while the pair of brush elements are displaced or deviated from each other in the direction of the rotational axis to allow the brush elements to come into contact with the slip rings, respectively, from the radial direction of the rotor at different positions in the direction of the rotational axis (see Patent Document 1, for example).

### PRIOR ART DOCUMENT

Patent Document 1: Japanese Unexamined Patent Application Publication No. 2004-52981

### SUMMARY OF THE INVENTION

### Problem to be Solved by the Invention

The conventional electromagnetic clutch noted above allows the pair of brush elements to come into contact with the pair of slip rings, respectively, from the radial direction of the rotor. This arrangement has an advantage that contact pressure of the brush elements relative to the slip rings is easily maintained at a predetermined pressure level, compared with an electromagnetic clutch in which the brush elements are brought into contact with the slip rings from the direction of the rotational axis.

More particularly, with respect to a shift or deviation caused by rotation of the rotor, a shift in the direction of the rotations axis is greater than a shift in the radial direction of the rotor. Therefore, if the brush elements are brought into contact with the slip rings from the direction of the rotational axis, contact pressure easily varies due to the shift in the direction of the rotational axis caused by rotation of the rotor. Further, such an arrangement tends to easily accumulate errors in the direction of the rotational axis in assembling the slip rings, brush elements and rotor. This makes it difficult to maintain contact pressure of the brush elements relative to the slip rings at a predetermined pressure level.

On the other hand, the arrangement in which the pair of slip rings are displaced or deviated from each other while the pair of brush elements are displaced or deviated from each other in the direction of the rotational axis has a disadvantage that the electromagnetic clutch would not be easily miniaturized in the direction of the rotational axis.

The present invention has been made having regard to the above-noted problem, and its object is to provide an electromagnetic clutch that can be easily miniaturized in the direction of the rotational axis while making use of the advantage that contact pressure of the brush elements relative to the slip rings is easily maintained at a predetermined pressure level.

### Means for Solving the Problem

In order to achieve the above-noted object, the present invention provides an electromagnetic clutch comprising:

a driven gear adapted to be rotatably driven by a motor;

a rotor rotatable with a rotational axis that is shared with the driven gear and having an electromagnetic coil provided at one end thereof along the rotational axis;

an armature mounted between the driven gear and the rotor to be rotatable in unison with the driven gear, and attracted by the rotor when current is applied to the electromagnetic coil;

a clutch case accommodating the driven gear, the rotor and the armature therein,

a pair of slip rings mounted on one of the rotor at a region adjacent the clutch case that faces away from the armature, and the clutch case at a region adjacent the rotor, the pair of slip rings being coaxial with the rotational axis and having different radii; and

a pair of brush elements mounted on the other of the rotor and the clutch case to come into contact with the pair of slip rings from a radial direction, respectively.

With this arrangement, each of the brush elements is brought into contact with each of the slip rings from the radial direction of the rotor without displacing the slip rings or the brush elements from each other in the direction of the rotational axis. Further, a shift or deviation of the rotor in the radial direction of the rotor caused by rotation of the rotor is minimized, as a result of which the electromagnetic clutch can be miniaturized in the direction of the rotational axis while contact pressure of the brush elements relative to the slip rings can be maintained at a predetermined pressure level.

Preferably, the electromagnetic clutch further comprises a clutch shaft connected to the rotor and supported to the clutch case to be rotatable about a rotational axis that is shared with the rotor;

wherein the rotor includes:
an extension connected to the clutch shaft and extending in the radial direction of the rotational axis;
an inner peripheral wall bent from the extension toward the clutch case;
a bottom wall extending from the inner peripheral wall in the radial direction of the rotational axis; and
an outer peripheral wall bent from the bottom wall toward the armature, the inner peripheral wall, bottom wall and outer peripheral wall forming a bobbin receiving recess together, and

wherein the pair of slip rings are provided in an inner peripheral side of the inner peripheral wall and an outer peripheral side of the outer peripheral wall, respectively.

With such an arrangement, the pair of brush elements can be brought into contact with the pair of slip rings individually from the radial direction while making effective use of a space defined between the inner peripheral side and the outer peripheral side, as a result of which the electromagnetic clutch can be miniaturized further in the direction of the rotational axis.

Preferably, the pair of brush elements are mounted on the same plane that is vertical to the rotational axis.

When the pair of brush elements are mounted on the same plane in this way, the slip rings can also be provided in the same plane that is vertical to the rotational axis. Thus, the electromagnetic clutch can be miniaturized further in the direction of the rotational axis.

Preferably, the clutch case includes a gear-side cover positioned adjacent the driven gear, and a feeding section-side cover engageable with the gear-side cover and having the slip rings or the brush elements.

Such an arrangement allows the clutch case to be formed as one piece after being assembled. This facilitates handling of the device in subsequent steps, and improves the reliability in assembly in an assembling line to follow. In addition, the rotary element such as the rotor is enclosed in the case, which prevents the rotary element from being damaged or scratched when foreign matters come flying.

Preferably, the electromagnetic clutch further comprises a ring holder mounted on the rotor adjacent the clutch case, the ring holder being insert-molded with the pair of slip rings being arranged coaxially with each other to hold the slip rings,

wherein each of the pair of slip rings has opposing elements that are opposed to each other with the pair of slip rings being arranged coaxially with each other, and

wherein the ring holder has at least one aperture for allowing a portion where the opposing elements are opposed to each other to be exposed to the outside.

With this arrangement, the assembly can be performed with accuracy. As a result, a shift or deviation caused by rotation of the rotor can be reduced.

Preferably, the at least one aperture includes a plurality of apertures, and wherein the portions where the opposing elements are opposed to each other in at least two of the apertures act as connecting terminals to be electrically connected to the electromagnetic coil.

With such an arrangement, the connecting terminals are easily formed and current is applied to the electromagnetic coil. In addition, the device is easy to handle because access to the connecting terminals is prohibited in assembling. Further, since the connecting terminals are enclosed in the ring holder, the device can have a reduced thickness and miniaturized.

The present invention also includes the ring holder in the protective scope. The ring holder preferably comprises:

a retaining portion for holding the pair of slip rings having opposing elements that are opposed to each other, respectively, with the pair of slip rings being arranged coaxially with each other by integrating the pair of slip rings by insert molding with being arranged coaxially with each other; and

a mounting portion for mounting the ring holder on the rotor adjacent the clutch case; and

an aperture for allowing a portion where the opposing elements are opposed to each other to be exposed to the outside.

With such a ring holder, the pair of slip rings are easily integrally assembled without assembling them individually.

Since the opposing position of the opposing elements can be observed from the outside through the aperture, one can easily make sure of the accuracy of the coaxial arrangement of the pair of slip ring.

The present invention further includes a method of manufacturing the ring holder in the protective scope. A method of manufacturing the ring holder preferably comprises:

a mounting step for mounting a slip ring forming member inside of a molding die for the ring holder with part of the slip ring forming member being exposed;

a molding step for integrating the slip ring forming member with the ring holder by insert molding; and

a cutting step for cutting off part of the slip ring forming member that is exposed to the outside to separate the pair of slip rings.

According to such a method, since the slip rings are integrated to a resin mold for the ring holder, assembling measurements in the direction of the rotational axis required for the ring holder and the slip rings can be reduced to further miniaturize the electromagnetic clutch in the direction of the rotational axis. In addition, since the slip ring forming member having the pair of slip rings connected to each other at a plurality of locations along the peripheral direction is resin-molded, the pair of slip rings can be fixed to be coaxial with each other accurately. Further, the pair of slip rings are separated by cutting off the connecting portions after the resin molding process, the ring holder can be easily manufactured dispensing with a step for assembling the slip rings and the ring holder mechanically.

### BRIEF DESCRIPTION OF THE DRAWINGS

FIG. 1 is a top plan view of an opening and closing device of a vehicle door;

FIG. 2 is a side view of the opening and closing device of the vehicle door;

FIG. 3 is a vertical sectional view taken on line III-III of FIG. 2;

FIG. 4 is a vertical sectional view showing an engaging state of an electromagnetic clutch;

FIG. 5 is an exploded perspective view of a principal portion of the electromagnetic clutch;

FIG. 6 is a top plan view of a principal portion of the electromagnetic clutch;

FIG. 7 is an explanatory view for illustrating a method of manufacturing a ring holder;

FIG. 8 is another explanatory view for illustrating a method of manufacturing the ring holder;

FIG. 9 is a further explanatory view for illustrating a method of manufacturing the ring holder; and

FIG. 10 is a still further explanatory view for illustrating a method of manufacturing the ring holder.

### MODE FOR CARRYING OUT THE INVENTION

Embodiments of the present invention will be described hereinafter in reference to the accompanying drawings. It should be noted that the present invention is not limited to the embodiments given below or the constructions shown in the drawings, but may include any other arrangement that is equivalent to those embodiment and constructions.

### First Embodiment

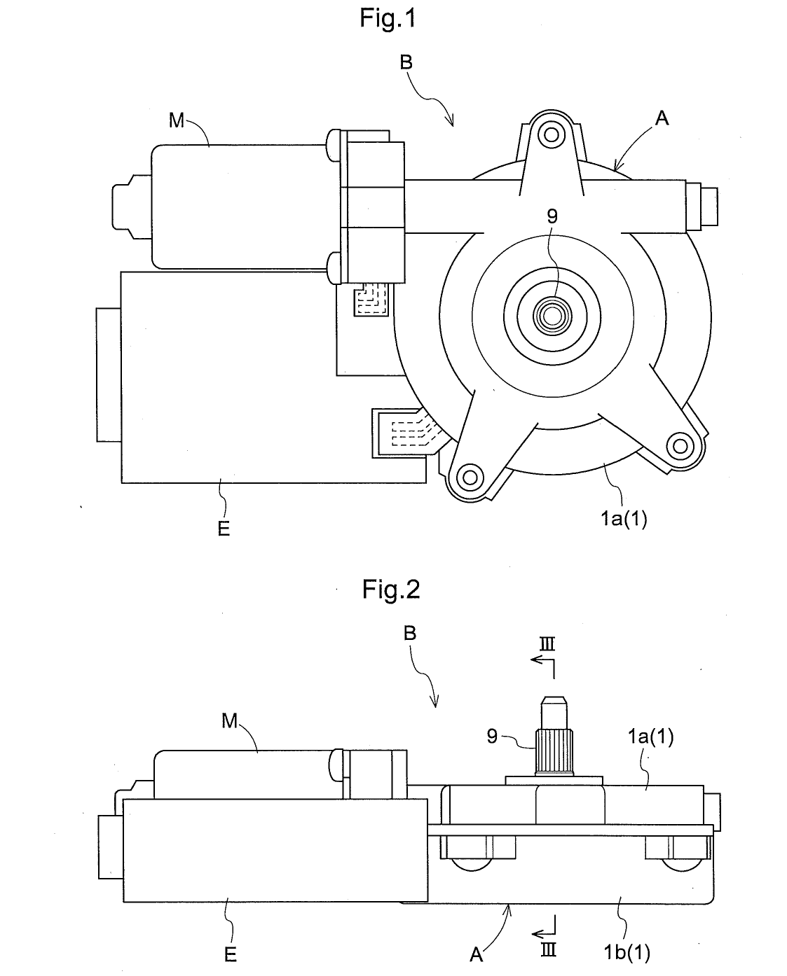

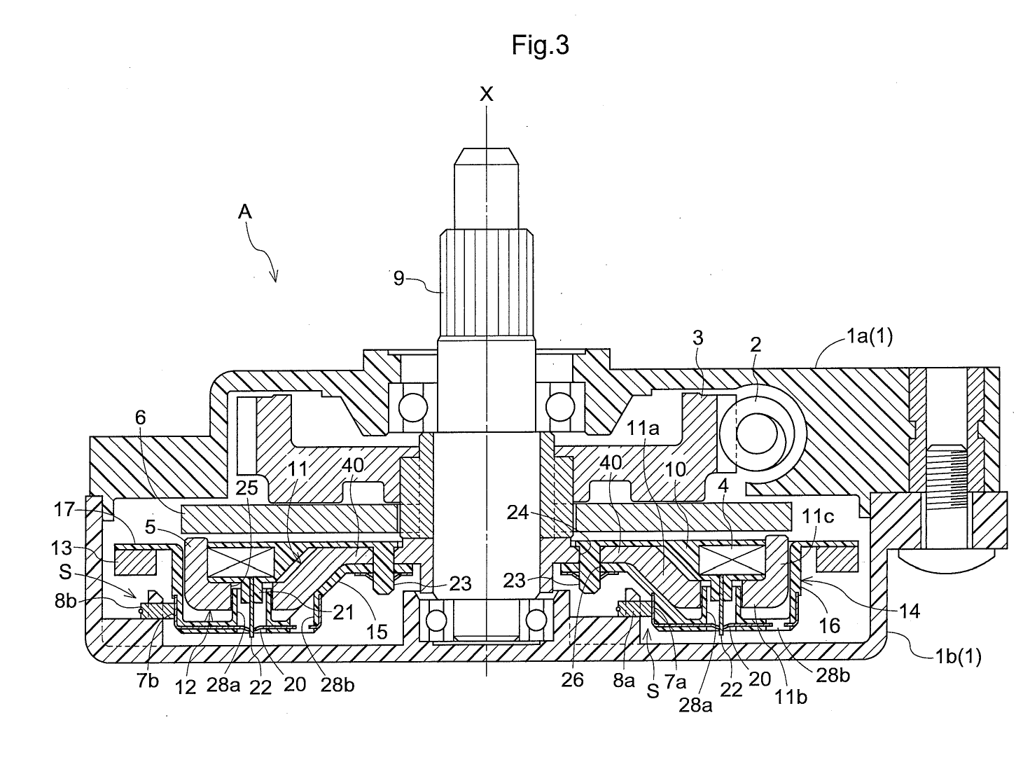

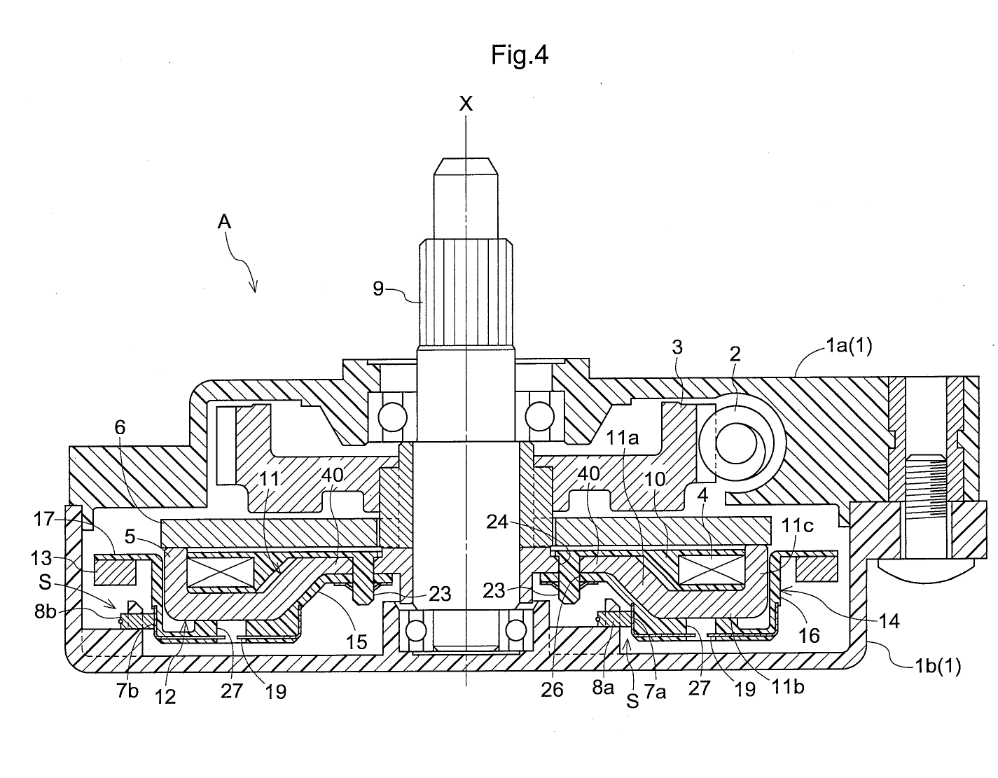

FIG. 1 is a top plan view of an opening and closing device B for a vehicle door provided with an electromagnetic clutch A in accordance with the present invention. FIG. 2 is a side view of the opening and closing device B for the vehicle door. FIGS. 3 and 4 are vertical sectional views of the electromagnetic clutch of the present invention.

As shown in FIGS. 1 to 4, the opening and closing device B for the vehicle door comprises an electric motor M acting as a driving source, the electromagnetic clutch A, and a control section E for controlling engagement and disengagement of the electromagnetic clutch A.

The electromagnetic clutch A is a self-rotation type including a clutch case 1 constructed by connecting a gear-side cover member 1a and a feeding section-side cover member 1b through bolts. The clutch case 1 includes a worm gear 2 directly connected to the electric motor M, a worm wheel 3 acting as a driven gear and adapted to be meshed with the worm gear 2 and rotatably driven by the electric motor M, a rotor 5 rotatable about a rotational axis X that is shared with the worm wheel 3 and having an electromagnetic coil 4 provided at one end thereof along the rotational axis X, an armature 6 rotatable in unison with the worm wheel 3, a clutch shaft 9 for transmitting rotation of the rotor 5, and a feeding section S for supplying electric power to the electromagnetic coil 4. The gear-side cover member 1a corresponds to a gear-side cover according to the present invention and is arranged adjacent the worm wheel 3. The feeding section-side cover member 1b is engaged with the gear-side cover member 1a and includes slip rings 7a and 7b or brush elements 8a and 8b. The clutch case 1 is constructed by such gear-side cover member 1a and feeding section-side cover member 1b.

The armature 6 is provided between the worm wheel 3 and the rotor 5 to be rotatable in unison with the worm wheel 3, and is attracted by the rotor 5 when current is applied to the electromagnetic coil 4 to be rotatable in unison with the rotor 5. In the feeding section S, the pair of band-like slip rings 7a and 7b are electrically connected to the electromagnetic coil 4 while the pair of brush elements 8a and 8b are brought into contact with the pair of slip rings 7a and 7b, respectively, from a radial direction of the rotor.

The armature 6 is made of a material that is attractable by a magnetic force from iron, for example. The rotor 5 is made of a magnetic material so as to exert an attracting force on the armature 6 by the magnetic force when current is applied to the electromagnetic coil 4. The rotor 5 is rotatable about the rotational axis X that is shared with the worm wheel 3. The rotor 5 and the armature 6 are housed in the feeding section-side cover member 1b.

FIG. 3 shows a state in which the electromagnetic clutch A is disengaged with the armature 6 being spaced from the rotor 5. FIG. 4 shows a state in which the electromagnetic clutch A is engaged with the armature 6 being attracted by the rotor 5 by power supply from the feeding section S to the electromagnetic coil 4.

The rotor 5 has an annular bobbin receiving recess 11 provided adjacent the armature 6 for receiving a bobbin 10 of the electromagnetic coil 4. The bobbin receiving recess 11 is formed by providing a projection 12 in the rotor 5 that is projected in the opposite direction to the armature 6.

The projection 12 has an inner peripheral wall 11a inclining closer to the rotational axis X adjacent the armature 6, a bottom wall 11b substantially vertical to the rotational axis X, and a outer peripheral wall 11c substantially parallel with the rotational axis X.

The clutch shaft 9 is connected to the rotor 5 and rotatably supported to the clutch case 1 to be rotatable about the rotational axis X that also acts as the rotational axis X of the rotor 5. The rotor 5 is connected to the clutch shaft 9 and has an extension 40 extending in the radial direction of the rotational axis X.

The inner peripheral wall 11a is bent toward the clutch case 1 from the extension 40. The bottom wall 11b extends toward the radial direction of the rotational axis X from the inner peripheral wall 11a. Further, the outer peripheral wall 11c is bent from the bottom wall 11b toward the armature 6. The inner peripheral wall 11a, bottom wall 11b and outer peripheral wall 11c form the bobbin receiving recess 11 together.

The bobbin 10 has a fitting pin 23 fitted into a fitting bore 24 formed in the rotor 5, and a pair of boss portions 21 holding a terminal element 22 in a projecting way for supplying electric power to the electromagnetic coil 4.

The pair of slip rings 7a and 7b are provided in the rotor 5 at a region adjacent the clutch case 1 that faces away from the armature 6, that is, at a region adjacent the projection 12 to be coaxial with the rotational axis X and to have a radius different from each other.

A ring holder 14 is resin-molded integrally with the pair of slip rings 7a and 7b with the slip rings 7a and 7b being arranged coaxially with each other.

The slip rings 7a and 7b have opposing elements 34 and 35, respectively, so that the opposing elements 34 and 35 in each pair are radially opposed to each other with the slip rings 7a and 7b being arranged coaxially with each other.

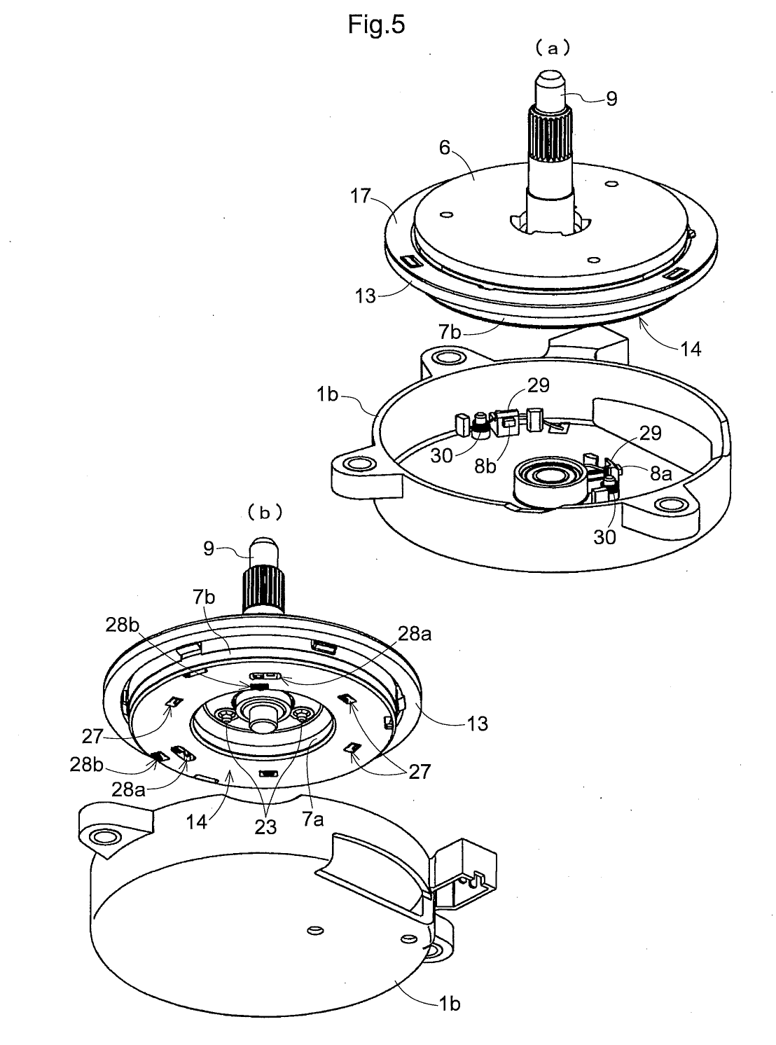

The ring holder 14 has apertures 27 and 28b formed therein for allowing portions where the opposing elements 34 or 35 are opposed to each other to be exposed to the outside. Both the apertures 27 and 28b are provided in plural (see FIG. 5). The opposing elements 34 and 35 positioned in at least two of the plurality of apertures 27 and 28b act as connecting terminals 20 that will be described later.

The ring holder 14 is also provided with a magnet holder 17 for holding a rotation detecting magnet 13.

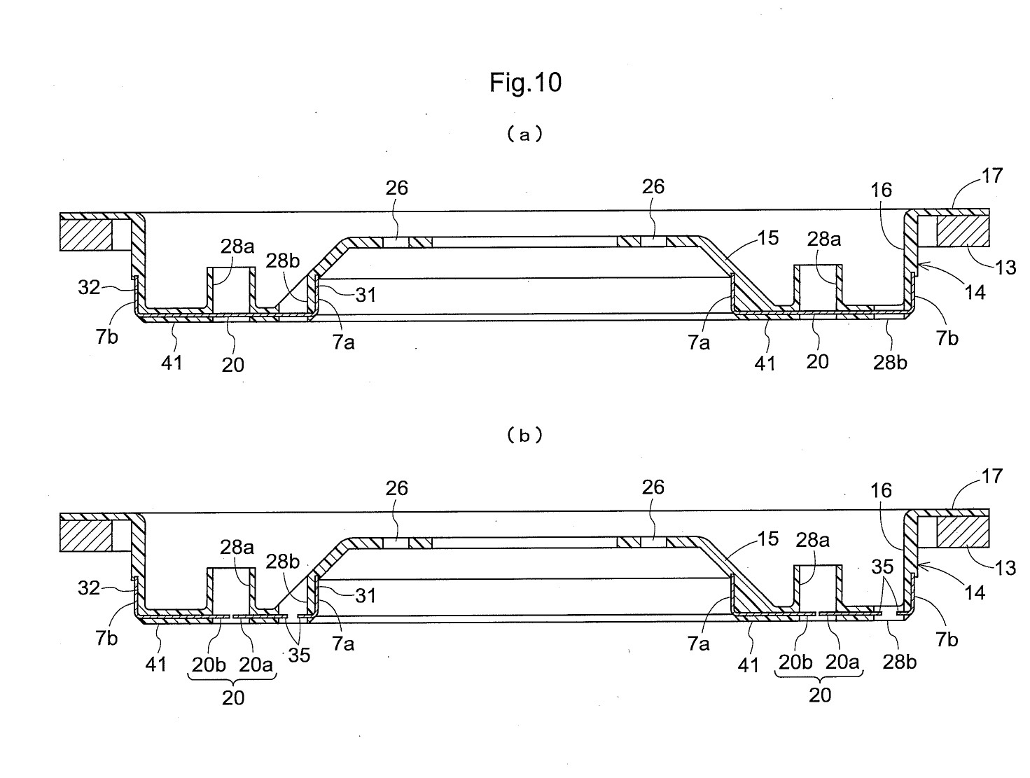

As shown in FIGS. 5 and 10, the ring holder 14 has a substantially disk-like shape including an inner circumferential wall 15 surrounding the inner peripheral side of the projection 12 and an outer circumferential wall 16 surrounding the outer peripheral side of the projection 12.

The inner circumferential wall 15 and the outer circumferential wall 16 have a pair of peripheral surface portions 31 and 32 at outside peripheral surfaces thereof. The peripheral surface portions 31 and 32 are arranged substantially parallel with and coaxially with the rotational axis X and have different diameters. The pair of slip rings 7a and 7b are attached to the pair of peripheral surface portions 31 and 32, respectively. That is, the pair of slip rings 7a and 7b are attached to the inner peripheral side of the inner peripheral wall 11a and the outer peripheral side of the outer peripheral wall 11c, respectively.

Hence, the pair of brush elements 8a and 8b can be brought into contact with the pair of slip rings 7a and 7b from the radial direction, respectively, by making effective use of a space defined between the outer peripheral side and the inner peripheral side of the bobbin receiving recess 11. As a result, the electromagnetic clutch A is miniaturized further in the direction of the rotational axis.

The pair of slip rings 7a and 7b are insert-molded with the ring holder 14 with the slip rings 71 and 7b being arranged coaxially with each other. More particularly, the ring holder 14 is insert-molded with the pair of slip rings 7a and 7b that have the opposing elements 34 and 35 being arranged coaxially with each other, thereby providing a retaining portion 41 for holding the slip rings 7a and 7b. This arrangement allows the ring holder 14 to hold the slip rings 7a and 7b together and attach them to the rotor 5 adjacent the clutch case 1.

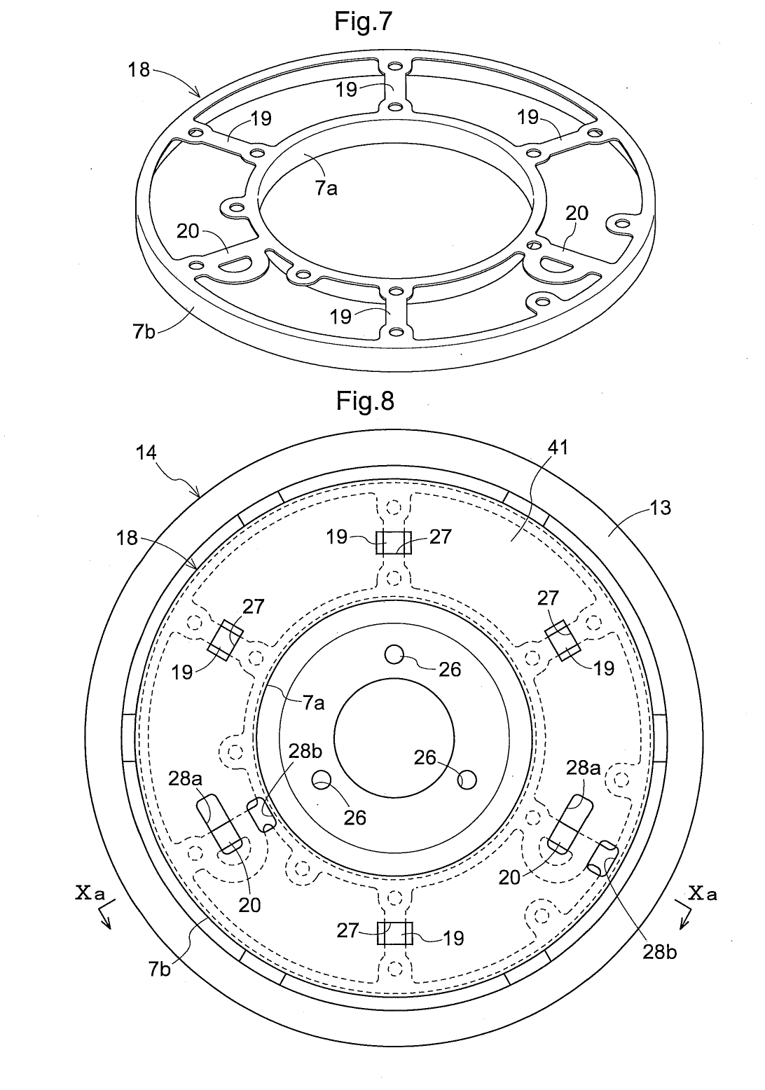

Next, a method of manufacturing the ring holder 14 will be described. FIG. 7 shows a slip ring forming member 18 made of sheet metal in which the pair of band-like slip rings 7a and 7b are arranged coaxially with each other and connected to each other at a plurality of connecting positions along a peripheral direction.

The slip ring forming member 18 includes the inner slip ring 7a and the outer slip ring 7b that are coaxially connected to each other in the peripheral direction through a plurality of connecting ribs 19. Each of the slip rings 7a and 7b is provided with connecting terminals 20 to be electrically connected to the electromagnetic coil 4. The connecting terminals 20 are also used as connecting elements for connecting the inner slip ring 7a and the outer slip ring 7b in the slip ring forming member 18.

Then, the slip ring forming member 18 is mounted inside of a molding die (not shown) for the ring holder 14 (mounting step) with part of the slip ring forming member 18 being exposed. As shown in FIGS. 8 and 10(a), the ring holder 14 is resin-molded, with brush contacting surfaces of the pair of slip rings 7a and 7b, front and back surfaces of intermediate portions of the connecting ribs (connecting positions) 19, front and back surfaces of terminal connecting portions of the connecting terminals 20, and front and back surfaces of ring connecting portions of the connecting terminals 20 connected to one of the slip rings 7a and 7b being exposed.

In other words, the ring holder 14 is resin-molded to form the apertures 27, 28a and 28b therein for exposing the intermediate portions of the connecting ribs 19, and the terminal connecting portions and the ring connecting portions of the connecting terminals 20 to the outside, respectively. This step is referred to as a molding step since the slip ring forming member 18 is insert-molded to the ring holder 14.

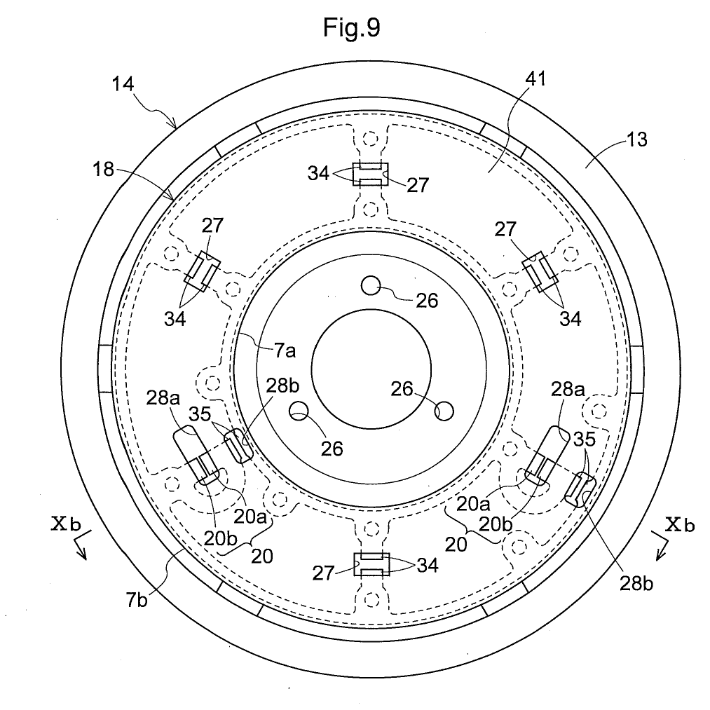

Then, as shown in FIGS. 9 and 10(b), the portions exposed at the respective apertures 27, 28a and 28b are cut off from the slip ring forming member 18 to fabricate the ring holder 14. This step is referred to as a cutting step since part of the slip ring forming member 18 that is exposed to the outside is cut off to separate the pair of slip rings.

More particularly, in the apertures 27 and 28b, the slip rings 7a and 7b are insulated and separated to provide the pair of slip rings 7a and 7b with the opposing elements 34 and 35 that are radially opposed to each other with the slip rings being arranged coaxially with each other.

In the aperture 28a, a pair of terminal strips 20a and 20b are formed for holding the terminal element 22 of the bobbin 10.

As shown in FIG. 3, the bobbin 10 allows the fitting pin 23 to be inserted and fitted to the fitting bore 24 formed in the rotor 5, and the boss portion 21 and terminal element 22 to be inserted into a through bores 25 formed in the rotor 5.

A distal end of the fitting pin 23 is forced into an engaging bore 26 formed on the ring holder 14 and acting as a mounting portion relating to the present invention to be retained therein. This allows the bobbin 10 and the ring holder 14 to be fixed to the rotor 5 to be rotatable in unison. The engaging bore 26 is formed in the rotor 5 adjacent the clutch case 1.

The terminal element 22 is forced into between the pair of terminal strips 20a and 20b through the aperture 28a to be electrically connected to the pair of slip rings 7a and 7b.

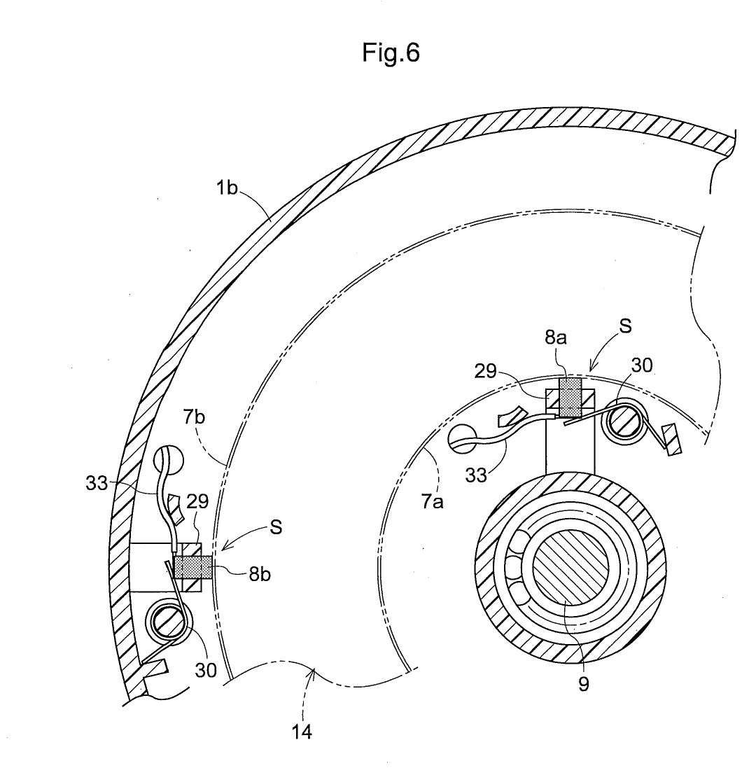

As shown in FIGS. 5 and 6, the pair of brush elements 8a and 8b are provided on the same plane that is vertical to the rotational axis X inside of the feeding section-side cover member 1b. More particularly, the brush elements 8a and 8b connected to conductive wires 33 are held by holders 29 fixed to an inner bottom surface of the feeding section-side cover member 1b to be movable toward the slip rings 7a and 7b. Helical springs 30 are provided to press and urge the brush elements 8a and 8b toward the slip rings 7a and 7b. Alternatively, plate springs (leaf springs) may be used instead of the helical springs to press and urge the brush elements 8a and 8b toward the slip rings 7a and 7b.

Since the pair of brush elements 8a and 8b are provided in the same plane that is vertical to the rotational axis X, the pair of slip rings 7a and 7b can also be provided in the same plane that is vertical to the rotational axis X. As a result, the electromagnetic clutch A can be miniaturized further in the direction of the rotational axis X.

### Second Embodiment

Although not shown, the pair of slip rings 7a and 7b that are arranged coaxially with the rotational axis X and have diameters different from each other may be separately provided in a region adjacent in the clutch case 1, specifically in the feeding section-side cover member 1b. In this case, the pair of brush elements 8a and 8b are provided in the clutch case 1 adjacent the rotor 5.

### Third Embodiment

Although now shown, the pair of brush elements provided on the same plane that is vertical to the rotational axis may be brush elements that are positioned to have their parts overlapping each other in the direction vertical to the rotational axis.

### Other Embodiments

The driven gear that is rotatably driven by the motor may be desirably selected among various gears other than the worm wheel.

The slip ring may have a slip surface that is inclined relative to the rotational axis.

The pair of slip rings may be positioned to have their parts overlapping each other in the direction vertical to the rotational axis.

The pair of slip rings may be mounted on a pair of peripheral surfaces formed on the rotor that have arranged coaxially with the rotational axis and having different diameters.

### INDUSTRIAL USABILITY

The present invention may be applied to an electromagnetic clutch that can be easily miniaturized in the direction of the rotational axis while making use of the advantage that contact pressure of brush elements relative to slip rings is easily maintained at a predetermined pressure level.

1. An electromagnetic clutch comprising:
a driven gear adapted to be rotatably driven by a motor;
a rotor rotatable with a rotational axis that is shared with the driven gear and having an electromagnetic coil provided at one end thereof along the rotational axis;
an armature mounted between the driven gear and the rotor to be rotatable in unison with the driven gear, and attracted by the rotor when current is applied to the electromagnetic coil;
a clutch case accommodating the driven gear, the rotor and the armature therein,
a pair of slip rings mounted on one of the rotor at a region adjacent the clutch case that faces away from the armature, and the clutch case at a region adjacent the rotor, the pair of slip rings being coaxial with the rotational axis and having different radii; and
a pair of brush elements mounted on the other of the rotor and the clutch case to come into contact with the pair of slip rings from a radial direction, respectively.

2. The electromagnetic clutch as claimed in claim 1 further comprising a clutch shaft connected to the rotor and supported to the clutch case to be rotatable about a rotational axis that is shared with the rotor;
wherein the rotor includes:
an extension connected to the clutch shaft and extending in the radial direction of the rotational axis;
an inner peripheral wall bent from the extension toward the clutch case;
a bottom wall extending from the inner peripheral wall in the radial direction of the rotational axis; and
an outer peripheral wall bent from the bottom wall toward the armature, the inner peripheral wall, bottom wall and outer peripheral wall forming a bobbin receiving recess together, and
wherein the pair of slip rings are provided in an inner peripheral side of the inner peripheral wall and an outer peripheral side of the outer peripheral wall, respectively.

3. The electromagnetic clutch as claimed in claim 1, wherein the pair of brush elements are mounted on the same plane that is vertical to the rotational axis.

4. The electromagnetic clutch as claimed in claim 1, wherein the clutch case includes a gear-side cover positioned adjacent the driven gear, and a feeding section-side cover engageable with the gear-side cover and having the slip rings or the brush elements.

5. The electromagnetic clutch as claimed in claim 1, further comprising a ring holder that is insert-molded with the pair of slip rings being arranged coaxially with each other to hold the slip rings and is mounted on the rotor adjacent the clutch case,
wherein each of the pair of slip rings has opposing elements that are opposed to each other with the pair of slip rings being arranged coaxially with each other, and
wherein the ring holder has at least one aperture for allowing a portion where the opposing elements are opposed to each other to be exposed to the outside.

6. The electromagnetic clutch as claimed in claim 5, wherein the at least one aperture includes a plurality of apertures, and wherein the portions where the opposing elements are opposed to each other in at least two of the apertures act as connecting terminals to be electrically connected to the electromagnetic coil.

7. A ring holder used in the electromagnetic clutch as claimed in claim 1, the ring holder comprising:
a retaining portion for holding the pair of slip rings having opposing elements that are opposed to each other, respectively, with the pair of slip rings being arranged coaxially with each other by integrating the pair of slip rings by insert molding with being arranged coaxially with each other; and
a mounting portion for mounting the ring holder on the rotor adjacent the clutch case; and
an aperture for allowing a portion where the opposing elements are opposed to each other to be exposed to the outside.

8. A method of manufacturing the ring holder as claimed in claim 7, the method comprising the steps of:
mounting a slip ring forming member inside of a molding die for the ring holder with part of the slip ring forming member being exposed;
insert molding the slip ring forming member to the ring holder; and
cutting off part of the slip ring forming member that is exposed to the outside to separate the pair of slip rings.
